(19) United States
(12) Patent Application Publication
(10) Pub. No.: US 2022/0025258 A1
(43) Pub. Date: Jan. 27, 2022

(54) UV-EMITTING PHOSPHOR, METHOD FOR PRODUCING SAME, AND UV EXCITATION LIGHT SOURCE

(71) Applicant: HAMAMATSU PHOTONICS K.K., Hamamatsu-shi, Shizuoka (JP)

(72) Inventors: Norio ICHIKAWA, Hamamatsu-shi, Shizuoka (JP); Kohei IKEDA, Hamamatsu-shi, Shizuoka (JP)

(73) Assignee: HAMAMATSU PHOTONICS K.K., Hamamatsu-shi, Shizuoka (JP)

(21) Appl. No.: 17/414,030

(22) PCT Filed: Dec. 16, 2019
(86) PCT No.: PCT/JP2019/049243

§ 371 Date: Jun. 15, 2021

(30) Foreign Application Priority Data
Dec. 17, 2018 (JP) 2018-235287

(51) Int. Cl. C09K 11/77; H01J 61/44; C01B 25/45

(52) U.S. Cl. CPC C09K 11/7777; H01J 61/44; C01P 2002/72; C01P 2002/50; C01P 2002/74; C01B 25/45

(57) ABSTRACT

A UV excitation light source comprises a phosphor. The phosphor contains ScₓY₁₋ₓPO₄ crystals (wherein 0<x<1), and, upon receiving UV light of a first wavelength, generates UV light of a second wavelength that is longer than the first wavelength. A method for producing the phosphor includes: a first step for producing a mixture that includes an oxide of Y, an oxide of Sc, phosphoric acid, and a liquid; a second step for vaporizing the liquid; and a third step for baking the mixture.

### TECHNICAL FIELD

The present disclosure relates to a UV emitting phosphor, a method for producing the same, and a UV excitation light source.

### BACKGROUND ART

Patent Literature 1 discloses a technique relating to an element that generates UV light using an excimer discharge means. This element includes a discharge tube, a discharge means, and a light emitting material. The discharge tube has a discharge space filled with a gas filling and is at least partially transparent to UV light. The discharge means causes and maintains an excimer discharge in the discharge space. The light emitting material includes a phosphorescent body having a maternal lattice represented by the general formula (Y_{1-x-y-z}LuₓSc_{y}A_{z}) PO₄. Here, 0≤x<1, 0<y≤1, 0<z<0.05, and A is an activator selected from the group consisting of bismuth, praseodymium, and neodymium.

### CITATION LIST

### Patent Literature

[Patent Literature 1] Japanese Unexamined Patent Publication No. 2008-536282

### SUMMARY OF INVENTION

### Technical Problem

Conventionally, UV light sources have been used for optical measurement, sterilization, disinfection, medical uses, or biochemistry. In UV light sources, for example, in addition to ones that output UV light generated from excimer discharge or the like, there are ones that output UV light having a wavelength longer than that of the UV light excited by irradiating a phosphor with UV light generated by excimer discharge or the like. In addition, in such a UV light source, for example, a phosphor useful for UV excitation having a composition different from a conventional composition as described in Patent Literature 1 is required. An object of the present disclosure is to provide a UV emitting phosphor useful for UV excitation having a composition different from a conventional composition, a method for producing the same, and a UV excitation light source.

### Solution to Problem

In order to solve the above-mentioned problems, a UV emitting phosphor according to one aspect of the present disclosure contains ScₓY₁₋ₓPO₄ crystals (where, 0<x<1) and receives UV light having a first wavelength to generate UV light having a second wavelength longer than the first wavelength. In addition, a method for producing a UV emitting phosphor according to one aspect of the present disclosure is a method for producing any of the above UV emitting phosphors, including a first step of preparing a mixture containing an oxide of yttrium (Y), an oxide of scandium (Sc), phosphoric acid or a phosphoric acid compound, and a liquid, a second step of vaporizing the liquid, and a third step of firing the mixture.

### Advantageous Effects of Invention

According to one aspect of the present disclosure, it is possible to provide a UV emitting phosphor useful for UV excitation having a composition different from a conventional composition, a method for producing the same, and a UV excitation light source.

### BRIEF DESCRIPTION OF DRAWINGS

FIG. 1 is a cross-sectional view showing a configuration of a UV excitation light source 10A including a UV emitting phosphor according to one embodiment, showing a cross-section including a central axis thereof.

FIG. 2 is a cross-sectional view along line II-II of the UV excitation light source 10A shown in FIG. 1, showing a cross-section perpendicular to the central axis.

FIG. 3 is a cross-sectional view showing a configuration of a UV excitation light source 10B, showing a cross-section including a central axis thereof.

FIG. 4 is a cross-sectional view of the UV excitation light source 10B shown in FIG. 3 along line IV-IV, showing a cross-section perpendicular to the central axis.

FIG. 5 is a cross-sectional view showing a configuration of a UV excitation light source 10C, showing a cross-section including a central axis thereof.

FIG. 6 is a cross-sectional view of the UV excitation light source 10C shown in FIG. 5 along line VI-VI, showing a cross-section perpendicular to the central axis.

FIG. 7 is a flowchart showing each process in a method for producing a phosphor 14.

FIG. 8 is a diagram schematically showing an experiment device used in an embodiment.

FIG. 9 is a graph showing a relationship between a firing temperature and a light emission intensity obtained in one embodiment.

FIG. 10 is a graph showing a light emission spectrum for each firing temperature obtained in an embodiment.

FIG. 11 is a graph showing a relationship between a concentration of Sc in components other than P and O and a light emission intensity obtained in an embodiment.

FIG. 12 is a chart showing numerical values on which FIG. 11 is based.

FIG. 13 is a graph showing a light emission spectrum for each Sc concentration.

FIG. 14 is a graph showing a light emission spectrum for each Sc concentration.

FIG. 15 is a graph showing a diffraction intensity waveform of each sample having a different firing temperature as measured by an X-ray diffractometer using CuKα rays.

FIG. 16 is an enlarged and superimposed graph of a diffraction intensity peak waveform near the <200> plane (near 2θ/θ=26°) in the diffraction intensity waveform at each firing temperature shown in FIG. 15.

FIG. 17 is a graph showing a relationship between the firing temperature and the diffraction peak intensity of the <200> plane.

FIG. 18 is a graph showing a relationship between a full width at half maximum of the diffraction intensity peak waveform corresponding to the <200> plane and the firing temperature.

FIG. 19 is a chart showing numerical values on which FIG. 18 is based.

FIG. 20 is a graph showing a light emission spectrum for each firing temperature obtained in a comparative example.

FIG. 21 is a graph in which a light emission spectrum G11 of a Sc:YPO₄ crystal having a firing temperature of 1600° C. and a light emission spectrum G12 in the case of further adding Bi to the Sc:YPO₄ crystal having the same firing temperature are superimposed.

FIG. 22 is a graph showing results of measuring light emission spectra by exciting samples prepared by using each of a liquid phase method and a solid phase method.

### DESCRIPTION OF EMBODIMENTS

A UV emitting phosphor according to one embodiment contains ScₓY₁₋ₓPO₄ crystals (where 0<x<1) and receives UV light having a first wavelength to generate UV light having a second wavelength longer than the first wavelength. According to an experiment performed by the author of the present disclosure, when the UV emitting phosphor having such a composition is irradiated with the UV light having the first wavelength (for example, around 172 nm), UV light having a wavelength longer than that of the UV light (specifically, around 240 nm) can be excited. Therefore, it is possible to provide a UV emitting phosphor useful for UV excitation having the composition different from a conventional composition.

In the above-mentioned UV emitting phosphor, a molar composition ratio x of Sc may be 0.02 or more and 0.6 or less. According to the experiment performed by the author of the present disclosure, when a concentration of Sc is within such a range, the emission intensity of UV light can be remarkably increased.

In the above-mentioned UV emitting phosphor, a full width at half maximum of a diffraction intensity peak waveform of a <200> plane measured by an X-ray diffractometer using CuKα rays may be 0.25° or less. According to the experiment performed by the author of the present disclosure, in this case, the emission intensity of UV light can be remarkably increased.

Further, a method for producing a UV emitting phosphor according to one embodiment is a method for producing any of the above UV emitting phosphors, including a first step of preparing a mixture containing an oxide of yttrium (Y), an oxide of scandium (Sc), phosphoric acid or a phosphoric acid compound, and a liquid, a second step of vaporizing the liquid, and a third step of firing the mixture. According to such a producing method, the above-mentioned UV emitting phosphor can be suitably produced. In addition, according to the experiments performed by the author of the present disclosure, such a liquid phase method (also referred to as a solution method) can further increase the emission intensity of UV light as compared with the method of simply mixing and firing an oxide of Y, an oxide of Sc, and phosphoric acid (or a phosphoric acid compound) powder (a solid phase method).

In the first step of the above-mentioned producing method, a mixing proportion of the oxide of Sc without the phosphoric acid and the phosphoric acid compound may be 1.2% by mass or more and 47.8% by mass or less. According to the experiment performed by the author of the present disclosure, in the case in which Sc has such a mixing proportion, the emission intensity of UV light can be remarkably increased.

In the third step of the above producing method, a firing temperature may be 1050° C. or higher. According to the experiment performed by the author of the present disclosure, in this case, the emission intensity of UV light can be remarkably increased.

Further, a UV excitation light source according to one embodiment includes any of the above UV emitting phosphors, and a light source that irradiates a UV emitting phosphor with UV light having a first wavelength. According to this UV excitation light source, by including any of the above UV emitting phosphors, it is possible to provide a UV light source including a light emitting material useful for UV excitation having a composition different from a conventional composition.

### DETAILS OF EMBODIMENTS

Hereinafter, embodiments of a UV emitting phosphor, a method for producing the same, and a UV excitation light source according to the present disclosure will be described in detail with reference to the accompanying drawings. Also, in the description of the drawings, the same elements will be denoted by the same reference numerals, and repeated descriptions thereof will be omitted.

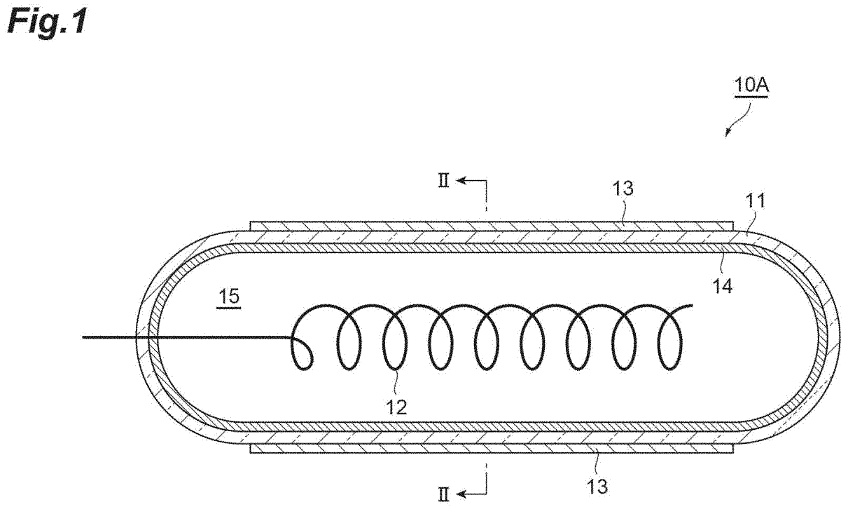

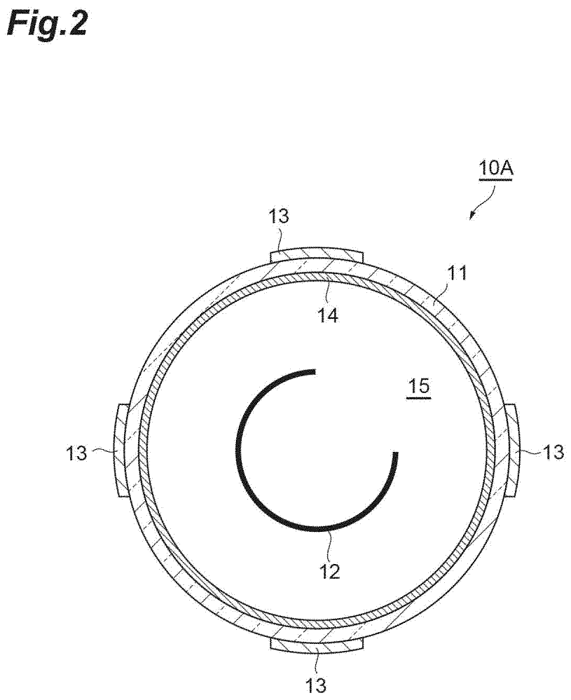

FIG. 1 is a cross-sectional view showing a configuration of a UV excitation light source 10A including a UV emitting phosphor according to one embodiment, and shows a cross-section including a central axis thereof. FIG. 2 is a cross-sectional view along line II-II of the UV excitation light source 10A shown in FIG. 1, showing a cross-section perpendicular to the central axis. As shown in FIGS. 1 and 2, the UV excitation light source 10A includes a vacuum-exhausted container 11, an electrode 12 disposed inside the container 11, a plurality of electrodes 13 disposed outside the container 11, and a UV emitting phosphor (hereinafter, simply referred to as a phosphor) 14 disposed on an inner surface of the container 11.

The container 11 has a shape such as a substantially cylindrical shape. One end and the other end of the container 11 in a central axis direction thereof are closed in a hemispherical shape, and an internal space 15 of the container 11 is hermetically sealed. A constituent material of the container 11 is, for example, quartz glass. Also, the constituent material of the container 11 is not limited to quartz glass as long as it is a material that transmits UV light output from the phosphor 14. For example, xenon (Xe) is sealed in the internal space 15 as a discharge gas.

The electrode 12 is, for example, a metal striatum, and is introduced into the internal space 15 from the outside of the container 11. In the example shown in FIGS. 1 and 2, the electrode 12 is bent in a spiral shape and extends from a position close to one end to a position close to the other end of the container 11 in the internal space 15. As shown in FIG. 2, the electrode 12 is disposed in a center of the internal space 15 in a cross-section perpendicular to the central axis of the container 11. The electrodes 13 are, for example, metal films that adhere to an outer wall surface of the container 11. In the example shown in FIGS. 1 and 2, four electrodes 13 are provided. The four electrodes 13 extend in the central axis direction of the container 11 and are arranged at equal intervals in a circumferential direction of the container 11.

A high frequency voltage is applied between the electrode 12 and the electrodes 13, and a discharge plasma is formed in a space between the electrode 12 and the electrodes 13 (that is, the internal space 15 of the container 11). As described above, the discharge gas is sealed in the internal space 15, and thus when the discharge plasma is generated, the discharge gas emits excimer light, and vacuum UV light is generated. In a case in which the discharge gas is Xe, a wavelength of the generated vacuum UV light is 172 nm.

The phosphor 14 is disposed in a film shape over the entire inner wall surface of the container 11. The phosphor 14 contains oxide crystals containing rare earth elements to which an activator is added. In the present embodiment, the activator is scandium (Sc). Further, the oxide crystals containing rare earth elements are oxides of yttrium (Y) and phosphorus (P), that is, YPO₄ (yttrium phosphoric acid). That is, the phosphor 14 contains ScₓY₁₋ₓPO₄ crystals (where 0<x<1), and in one embodiment, it is composed of ScₓY₁₋ₓPO₄ crystals. The phosphor 14 is excited by the vacuum UV light generated in the internal space 15 and generates UV light having a wavelength longer than that of the vacuum UV light (for example, 241 nm). The UV light generated from the phosphor 14 passes through the container 11 and is output to the outside of the container 11 through gaps between the plurality of electrodes 13. That is, the electrode 12, the electrodes 13, and the discharge gas in the internal space 15 constitute a light source that irradiates the phosphor 14 with UV light having a first wavelength (for example, 172 nm). Then, the phosphor 14 receives the UV light having the first wavelength and generates UV light having a second wavelength (for example, 241 nm) longer than the first wavelength. A film thickness of the phosphor 14 is, for example, 0.1 μm or more and 1 mm or less.

As shown in the examples that will be described later, a molar composition ratio of Sc in components other than P and O, that is, a composition x of Sc, may be 0.02 or more, or 0.6 or less. In other words, a concentration of Sc (which may hereinafter be simply referred to as a Sc concentration) in the components other than P and O may be 2 mol % or more, or 60 mol % or less. In this case, the emission intensity of UV light (in other words, conversion efficiency of the energy of UV light having a first wavelength into UV light having a second wavelength) can be significantly increased. Alternatively, the composition x of Sc may be 0.03 or more, 0.04 or more, or 0.05 or more. In other words, the Sc concentration may be 3 mol % or more, 4 mol % or more, or 5 mol % or more. At such a concentration level, the emission intensity of UV light can be further increased as the concentration increases. Further, the composition x of Sc may be 0.5 or less, 0.4 or less, or 0.3 or less. In other words, the Sc concentration may be 50 mol % or less, 40 mol % or less, or 30 mol % or less. At such a concentration level, the emission intensity of UV light can be further increased as the concentration decreases.

A degree of crystallization of the phosphor 14 changes in accordance with a sintering temperature. As shown in the examples below, a full width at half maximum of a diffraction intensity peak waveform of the <200> plane of the phosphor 14 measured by an X-ray diffraction (XRD) meter using CuKα rays (a wavelength of 1.54 Å) may be 0.25° or less. In this case as well, the emission intensity of UV light can be significantly increased. Alternatively, this full width at half maximum may be 0.20° or less, 0.18° or less, or 0.16° or less. In this case, the emission intensity of UV light can be further increased.

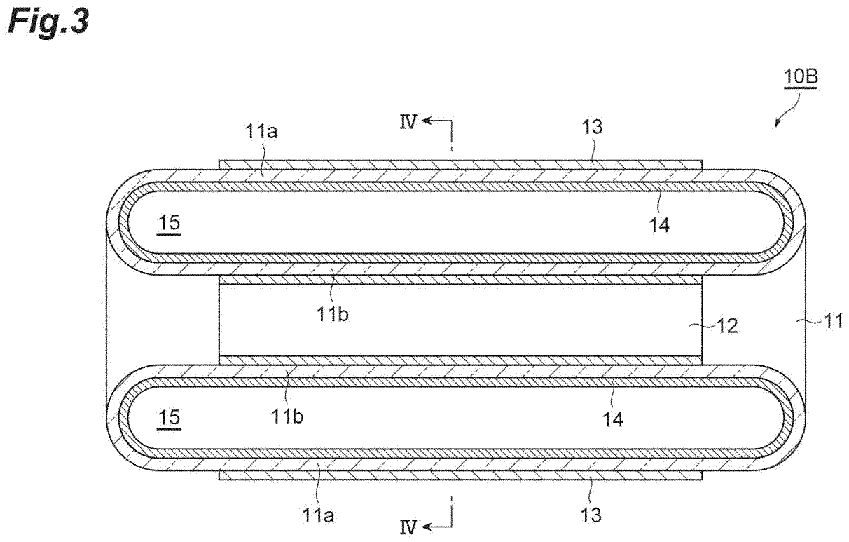

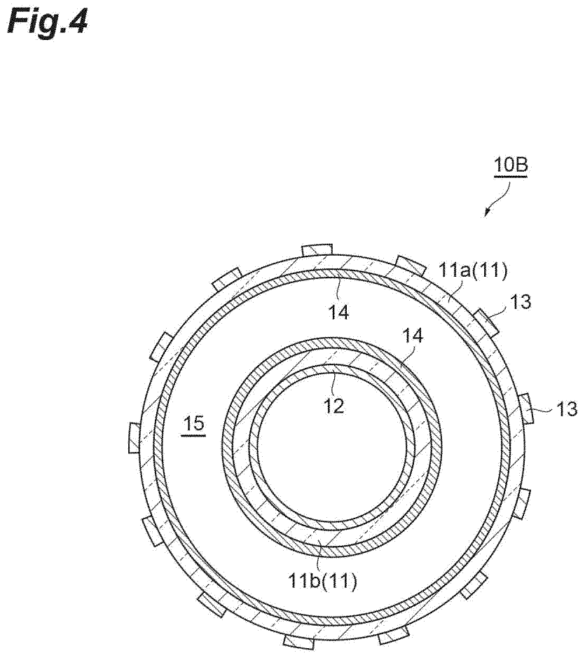

FIG. 3 is a cross-sectional view showing a configuration of another UV excitation light source 10B including a UV emitting phosphor, and shows a cross-section including a central axis thereof. FIG. 4 is a cross-sectional view along line IV-IV of the UV excitation light source 10B shown in FIG. 3, showing a cross-section perpendicular to the central axis. As shown in FIGS. 3 and 4, the UV excitation light source 10B includes a container 11, an electrode 12, a plurality of electrodes 13, and a phosphor 14. A difference between the UV excitation light source 10B and the above-mentioned UV excitation light source 10A is a shape of the container 11 and the electrode 12.

That is, the container 11 of the UV excitation light source 10B has a double cylindrical shape and includes an outer cylindrical portion 11a and an inner cylindrical portion 11b. A gap between the inner cylindrical portion 11b and the outer cylindrical portion 11a is closed at both ends of the container 11 in the central axis direction and constitutes the airtightly sealed internal space 15. Further, the electrode 12 is disposed inside the inner cylindrical portion 11b. For example, the electrode 12 is a metal film formed on an inner wall surface of the inner cylindrical portion 11b. The electrode 12 extends from a position close to one end to a position close to the other end of the inner cylindrical portion 11b.

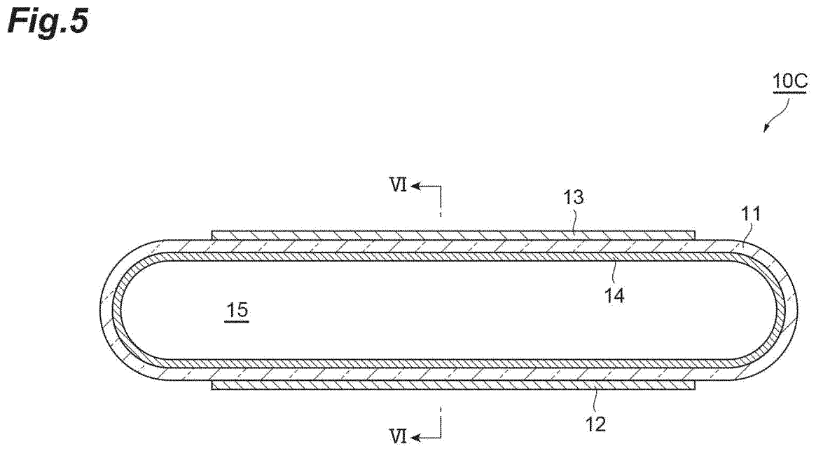

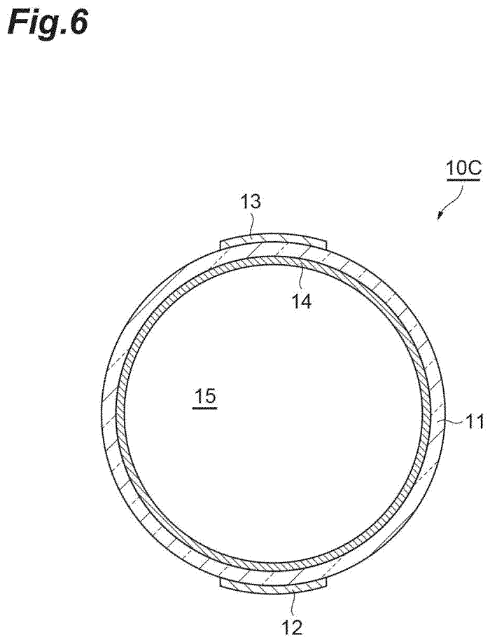

FIG. 5 is a cross-sectional view showing a configuration of another UV excitation light source 10C including a UV emitting phosphor, showing a cross-section including a central axis thereof. FIG. 6 is a cross-sectional view along line VI-VI of the UV excitation light source 10C shown in FIG. 5, showing a cross section perpendicular to the central axis. As shown in FIGS. 5 and 6, the UV excitation light source 10C includes a container 11, an electrode 12, an electrode 13, and a phosphor 14. A difference between the UV excitation light source 10C and the above-mentioned UV excitation light source 10A is an aspect of the electrodes 12 and 13.

That is, the electrode 12 of the UV excitation light source 10C is disposed outside the cylindrical container 11. In one example, the electrode 12 is a metal film formed on an outer wall surface of the container 11. Further, the electrode 13 is disposed on the outer wall surface of the container 11 at a position facing the electrode 12 with the central axis interposed therebetween. The electrodes 12 and 13 extend in a central axis direction thereof.

In the above-mentioned UV excitation light sources 10B and 10C, when a high voltage is applied between the electrodes 12 and 13, a discharge plasma is also formed in the internal space 15 of the container 11. Then, the discharge gas emits excimer light, and vacuum UV light is generated. The phosphor 14 is excited by the vacuum UV light generated in the internal space 15 and generates UV light having a wavelength longer than that of the vacuum UV light. The UV light generated from the phosphor 14 passes through the outer cylindrical portion 11a of the container 11 and is output to the outside of the container 11 through a gap between the plurality of electrodes 13 or a gap between the electrodes 12 and 13.

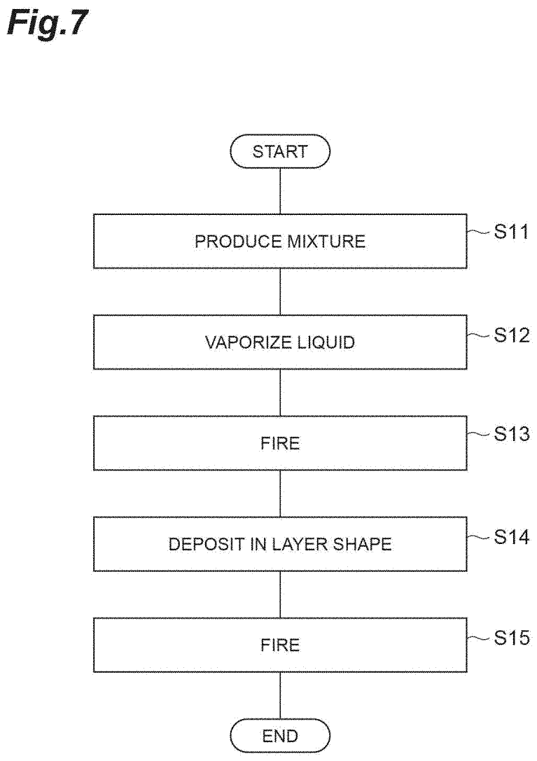

FIG. 7 is a flowchart showing each process included in a method for producing the phosphor 14. First, in a first step S11, a mixture including an oxide of Y (Y₂O₃), an oxide of Sc (Sc₂O₃), phosphoric acid (H₃PO₄) or a phosphoric acid compound (for example, ammonium dihydrogen phosphate (NH₄H₂PO₄)), and a liquid (for example, pure water) is prepared. Specifically, the oxide of Y, the oxide of Sc, and the phosphoric acid are put into the liquid contained in the container and are sufficiently stirred. A time required for stirring is, for example, 24 hours. As a result, the phosphoric acid and each oxide are reacted with each other in the container and aged.

In this first step S11, a mixing proportion of the oxide of Sc may be 1.2% by mass or more and 47.8% by mass or less. Thus, the phosphor 14 in which a concentration of Sc in components without P and O is 2 mol % or more and 60 mol % or less (that is, a composition x of Sc is 0.02 or more and 0.6 or less) can be suitably prepared. Alternatively, the mixing proportion of the oxide of Sc may be 1.9% by mass or more, 2.5% by mass or more, or 3.1% by mass or more. Further, the mixing proportion of the oxide of Sc may be 37.9% by mass or less, 28.9% by mass or less, or 20.7% by mass or less.

Next, in a second step S12, the above mixture is heated to vaporize the liquid. Thus, a powdery mixture obtained by removing the liquid from the above mixture is prepared. In one example, the heating temperature is in the range of 100 to 300° C. and a heating time is in the range of 1 to 5 hours.

Subsequently, in a third step S13, the mixture is fired (heat treated). Specifically, first, the mixture put in a crucible is placed in a heat treatment furnace (for example, an electric furnace). Then, the mixture is heat-treated in the air and then fired. The firing temperature at this time is, for example, 1050° C. or higher and 1700° C. or lower. A firing time is, for example, in the range of 1 to 100 hours. This causes the constituent materials of the mixture to be crystallized. Also, the firing temperature may be, for example, 1100° C. or higher, 1200° C. or higher, 1300° C. or higher, 1400° C. or higher, or 1500° C. or higher. In one embodiment, the firing temperature is 1600° C. In the temperature range of 1600° C. or lower, a degree of crystallization of the phosphor 14 increases as the firing temperature increases, and the emission intensity of UV light can be further increased.

Subsequently, in a fourth step S14, the fired mixture is disposed in a layer shape on the inner wall surface of the container 11. At this time, the powdery mixture may be placed on the inner wall surface of the container 11 as it is, or a sedimentation method may be used. The sedimentation method is a method of putting the powdery mixture into a liquid such as alcohol, dispersing the mixture in the liquid using ultrasonic waves or the like, naturally settling the mixture on the inner wall surface of the container 11 disposed at a bottom portion of the liquid, and then drying it. By using such a method, the mixture can be deposited on the inner wall surface of the container 11 with a uniform density and thickness. In this way, the phosphor 14 is formed on the inner wall surface of the container 11.

Subsequently, in a fifth step S15, the phosphor 14 may be fired (heat-treated) again. This firing is carried out in the air for the purpose of sufficiently vaporizing the alcohol and for the purpose of increasing the adhesion between the container 11 and the mixture and between the mixtures. The firing temperature at this time is, for example, 1100° C. and the firing time is, for example, 2 hours.

Also, in the above description, the mixture is deposited on the inner wall surface of the container 11 after the mixture is fired, but the mixture before firing may be fired after the mixture is deposited on the inner wall surface of the container 11. In that case, the mixture may be deposited on the inner wall surface of the container 11 using the sedimentation method described above, or may be performed using a method of mixing with an organic substance as a binder, applying the mixture, and then firing them to remove them.

Effects obtained by the phosphor 14, the method for producing the same, and the UV excitation light sources 10A to 10C of the present embodiment described above will be described. As described above, the phosphor 14 of the phosphor 14 includes the ScₓY₁₋ₓPO₄ crystals (where 0<x<1). According to an experiment performed by the author of the present disclosure described later, when the phosphor 14 having such a composition is irradiated with vacuum UV rays having a wavelength of, for example, 172 nm, UV light having a wavelength of around 240 nm (241 nm in the experiment) can be excited. Therefore, according to the present embodiment, it is possible to provide the phosphor 14 useful for UV excitation having a composition different from a conventional composition.

Further, as shown in FIG. 7, the method for producing the phosphor 14 according to the present embodiment includes the first step S11 of preparing the mixture containing the oxide of Y, the oxide of Sc, the phosphoric acid, and the liquid, the second step S12 of heating the mixture to vaporize the liquid, and the third step S13 of firing the mixture. According to such a producing method, the phosphor 14 can be suitably prepared. In addition, as shown in the examples described later, using such a liquid phase method (also referred to as a solution method), the emission intensity of UV light can be further increased as compared with the method of simply mixing and firing the oxide of Y, the oxide of Sc, and the phosphoric acid powder (solid phase method).

As described above, the concentration of Sc contained in the YPO₄ crystal may be 2 mol % or more and 60 mol % or less. Also, for that reason, in the first step S11, the mixing proportion of the oxide of Sc may be 1.2% by mass or more and 47.8% by mass or less. According to the experiment performed by the author of the present disclosure described later, in a case in which the concentration of Sc is within such a range, the emission intensity of UV light can be remarkably increased.

As described above, the full width at half maximum of the diffraction intensity peak waveform of the <200> plane measured by an X-ray diffractometer using CuKα rays may be 0.25° or less. Further, for that reason, in the third step S13, the firing temperature may be set to 1050° C. or higher. According to the experiment performed by the author of the present disclosure described later, the emission intensity of UV light can be remarkably increased in such a case.

Further, the UV excitation light sources 10A to 10C according to the present embodiment include the phosphor 14 and the light source (the electrodes 12 and 13, and the discharge gas) that irradiate the phosphor 14 with UV light. According to the UV excitation light sources 10A to 10C, by including the phosphor 14, it is possible to provide a UV light source including a light emitting material useful for UV excitation having a composition different from a conventional composition.

### First Example

Here, a first example of the above embodiment will be described. The author of the present disclosure actually prepared a plurality of samples (Sc:YPO₄) as the phosphor 14 using the method described below. First, Y₂O₃, Sc₂O₃, and H₃PO₄ were mixed with pure water to prepare a plurality of mixtures. At this time, a proportion of Sc₂O₃ in each mixture was made different from each other so that the concentration of Sc in the components without P and O of each sample becomes 0 mol %, 2 mol %, 5 mol %, 8 mol %, 10 mol %, 12 mol %, 15 mol %, 20 mol %, 40 mol %, 60 mol %, 80 mol %, and 100 mol %, respectively. Next, each mixture was sufficiently stirred over 24 hours to allow Y₂O₃, Sc₂O₃, and H₃PO₄ to react with each other, and aged. Then, the mixture was heated to vaporize the pure water to obtain a powdery mixture. Subsequently, the mixture was fired in the air. At this time, the sample having a Sc concentration of 5 mol % was further divided into a plurality of samples, one of which was not fired, and the other samples were fired at 800° C., 1000° C., 1100° C., 1200° C., 1400° C., 1500° C., 1600° C., and 1700° C., respectively. Further, for the 2 mol %, 8 mol %, 10 mol %, 12 mol %, 15 mol %, and 20 mol % samples among the samples having other Sc concentrations, the firing temperature was set to 1600° C. For 0 mol %, 40 mol %, and 60 mol % samples, the firing temperature was set to 1400° C. and 1600° C., and for the 80 mol % and 100 mol % samples, the firing temperature was set to 1400° C. The firing time was 2 hours. Then, the samples were deposited in a layer shape on disk-shaped quartz substrates using the above-mentioned sedimentation method. Then, they were fired at 1100° C. for 2 hours in the air.

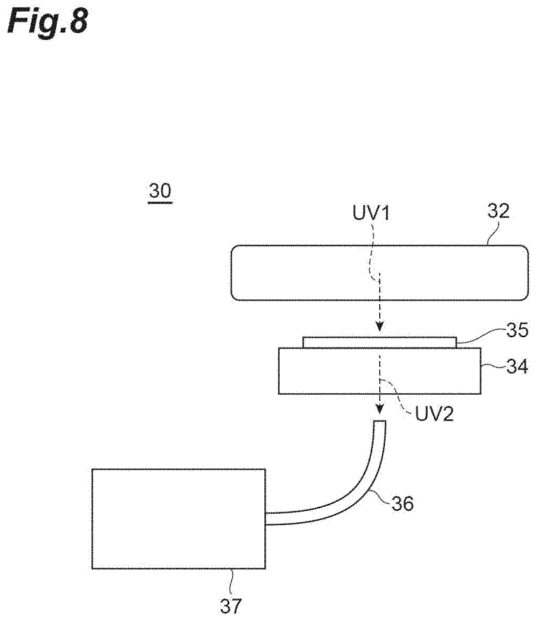

FIG. 8 is a diagram schematically showing an experiment device used in the present examples. This device 30 includes a UV light source 32 disposed to face a sample 35 on a quartz substrate 34. The UV light source 32 is an excimer lamp (manufactured by Hamamatsu Photonics) in which Xe serving as a discharge gas is sealed in a glass container. An emission wavelength of the UV light source 32 is 172 nm. From this UV light source 32, the sample 35 on the quartz substrate 34 was irradiated with UV light UV1. One end of an optical fiber 36 is opposed to a back surface of the quartz substrate 34 (a surface opposite to a surface on which the sample 35 is disposed), and the other end of the optical fiber 36 is connected to a spectroscopic detector 37 (manufactured by Hamamatsu Photonics, Photonic Multi-Analyzer PMA-12, model number C10027-01). Among UV light UV2 generated by exciting the sample 35 with the UV light UV1, the UV light UV2 transmitted through the quartz substrate 34 was taken into the spectroscopic detector 37 via the optical fiber 36 and the measurement was performed.

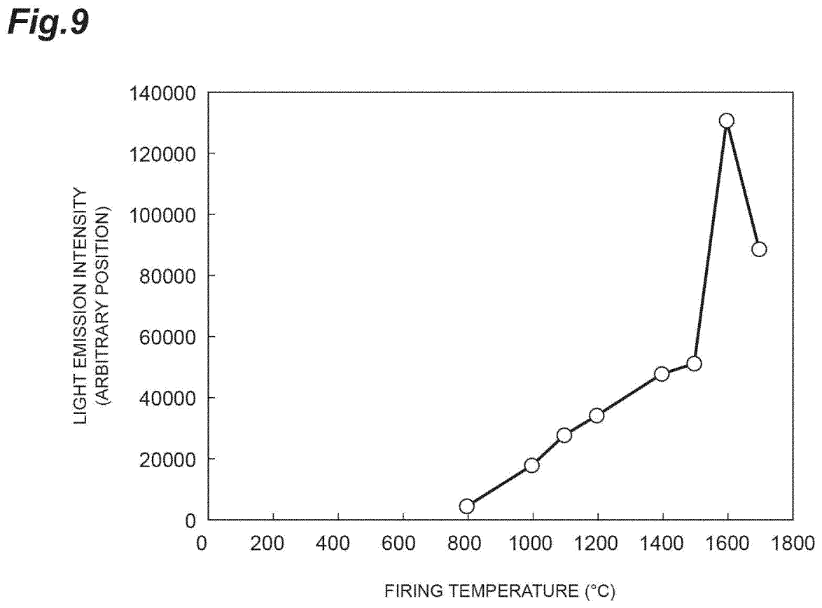

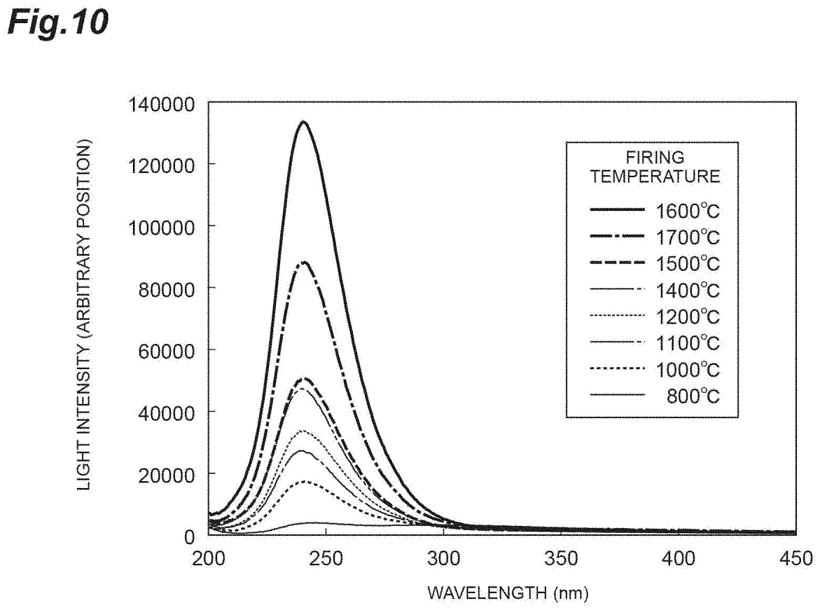

FIG. 9 is a graph showing a relationship between the firing temperature and the light emission intensity obtained by the device 30. Further, FIG. 10 is a graph showing a light emission spectrum for each firing temperature obtained by the device 30. As is clear from FIGS. 9 and 10, the light emission intensity is highest when the firing temperature is 1600° C., and the light emission intensity gradually increases as the firing temperature increases up to 1600° C. In particular, the light emission intensity is remarkably increased from 1000° C. to 1100° C. That is, by setting the firing temperature to 1050° C. or higher, the light emission intensity can be remarkably increased. Also, although the light emission intensity decreases when the firing temperature exceeds 1600° C., sufficient light emission intensity is obtained even in a case in which the firing temperature is 1700° C.

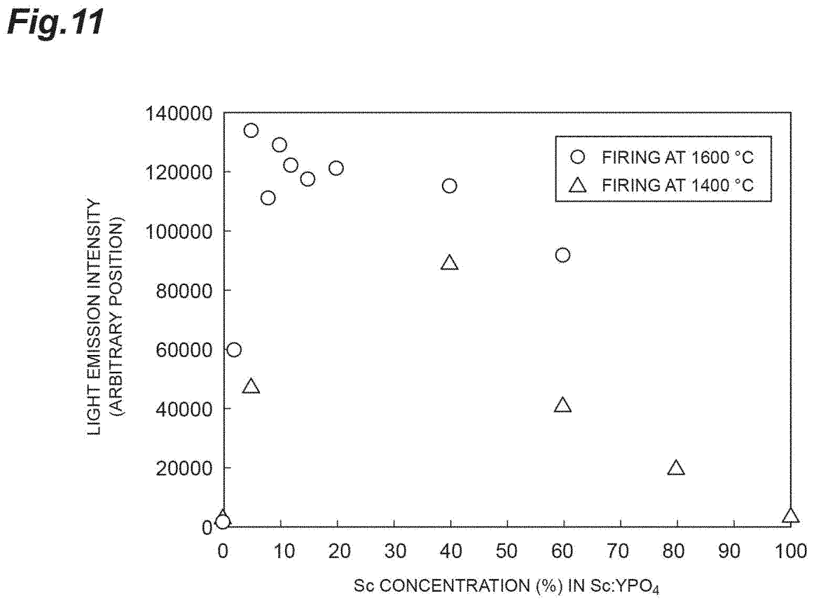

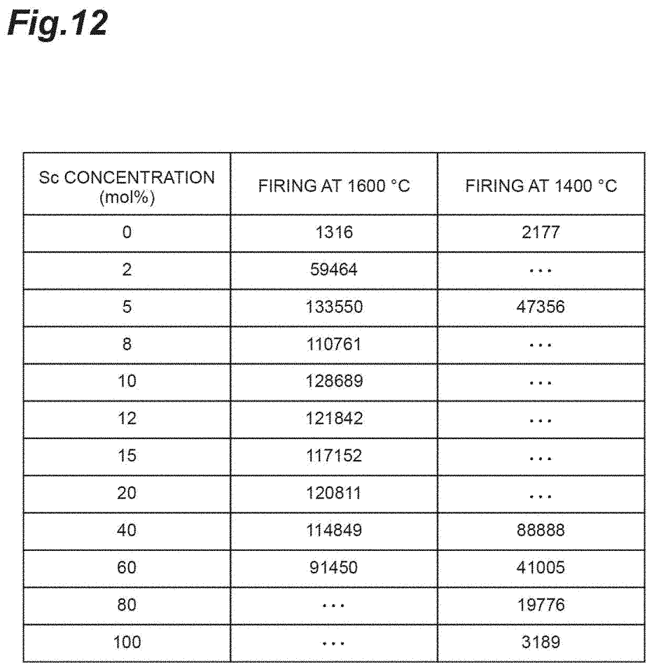

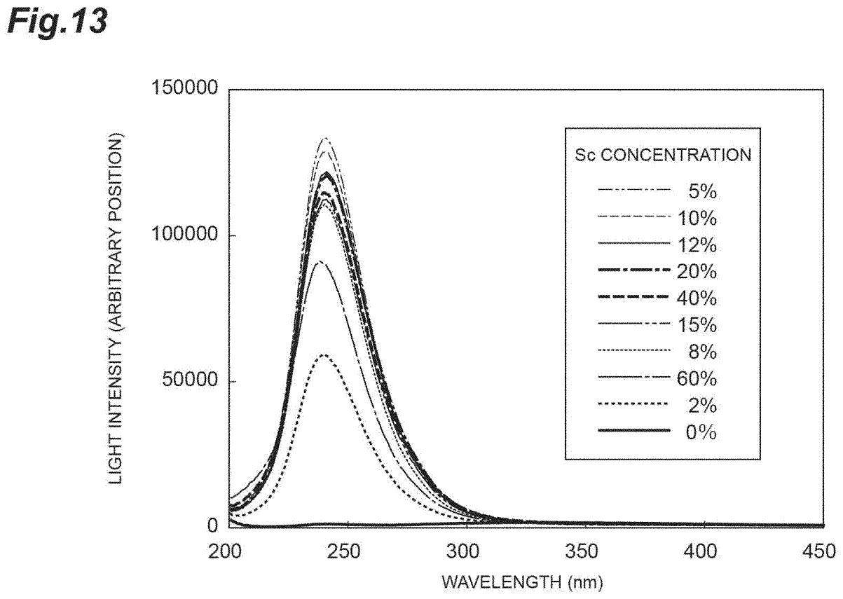

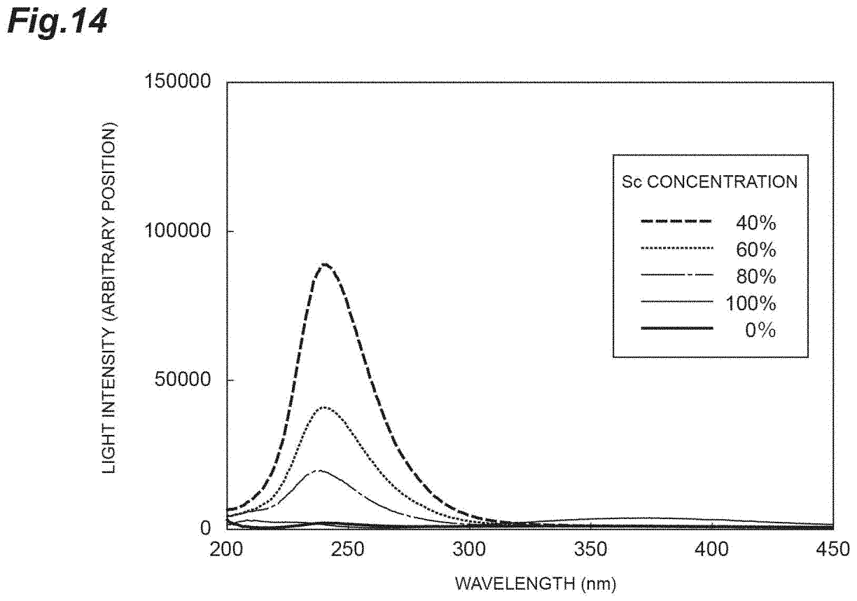

FIG. 11 is a graph showing a relationship between the concentration of Sc in the components without P and O and the light emission intensity obtained by the device 30. Also, in the figure, a is a plot in a case in which the firing temperature is 1600° C., and A is a plot in a case in which the firing temperature is 1400° C. FIG. 12 is a chart showing numerical values on which FIG. 11 is based. Further, FIGS. 13 and 14 are graphs showing light emission spectra for each Sc concentration obtained by the device 30. As is clear from FIGS. 11 to 14, the light emission intensity is highest when the Sc concentration is 5 mol %, and a relatively high light emission intensity is obtained in the range of 2 mol % to 60 mol %. However, in the range larger than 40 mol %, the light emission intensity gradually decreases as the Sc concentration increases.

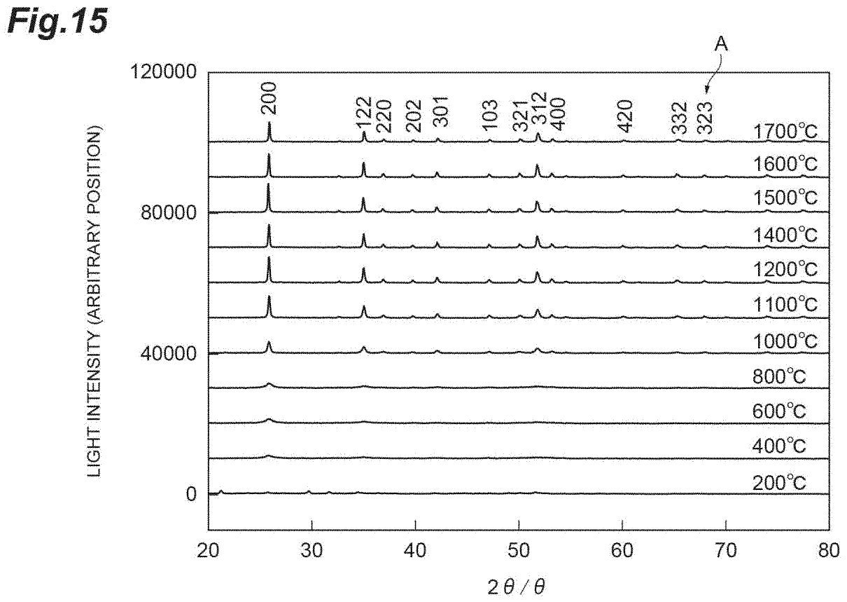

Here, results of investigating a relationship between the firing temperature and crystallinity of the samples will be described. FIG. 15 is a graph showing a diffraction intensity waveform of each sample (the Sc concentration is 5 mol %) having different firing temperatures as measured by an X-ray diffractometer using CuKα rays. In the figure, the firing temperature corresponding to each diffraction intensity waveform is also shown. Further, a plurality of numerical values A shown in the figure represent a crystal plane orientation corresponding to a peak of each diffraction intensity waveform. With reference to FIG. 15, it can be seen that a slight diffraction line appears when the firing temperature exceeds 400° C. In addition, as the firing temperature increases, the diffraction line becomes clearer and the diffraction peak intensity increases.

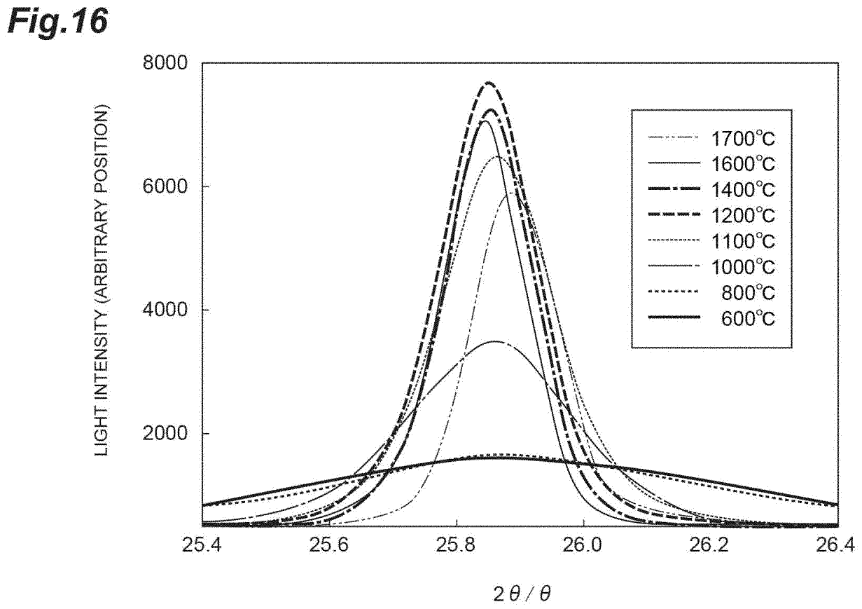

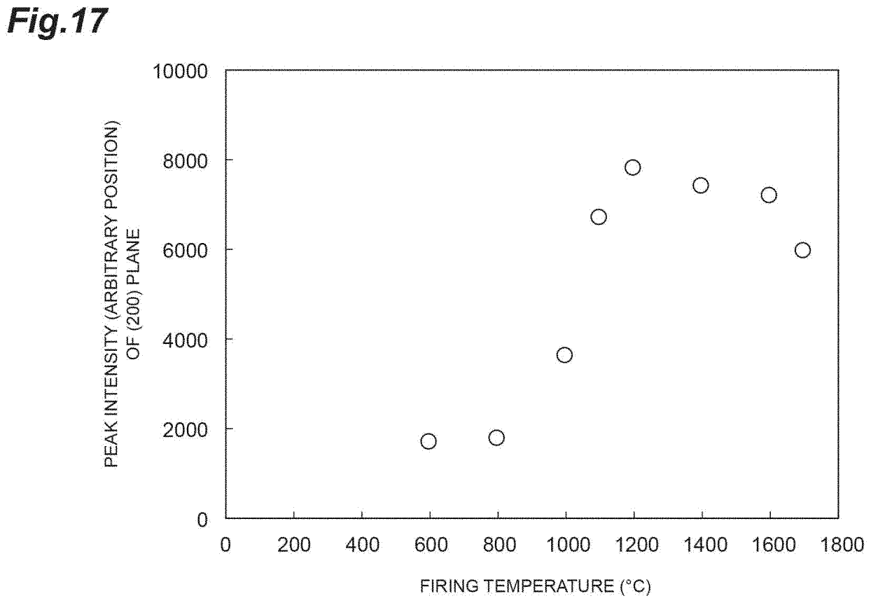

FIG. 16 is an enlarged and superimposed graph of the diffraction intensity peak waveform near the <200> plane (near 2θ/θ=26°) in the diffraction intensity waveform at each firing temperature shown in FIG. 15. Further, FIG. 17 is a graph showing a relationship between the firing temperature and the diffraction peak intensity of the <200> plane. With reference to FIG. 17, it can be seen that the diffraction peak intensity of the <200> plane gradually increases as the firing temperature increases, but it begins to saturate at a firing temperature of around 1100° C. and completely saturates at a firing temperature of around 1200° C.

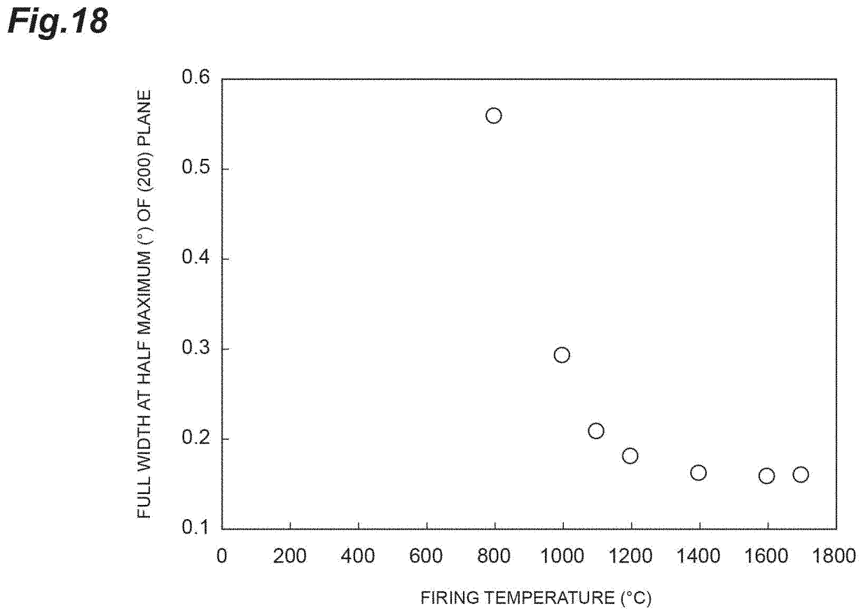

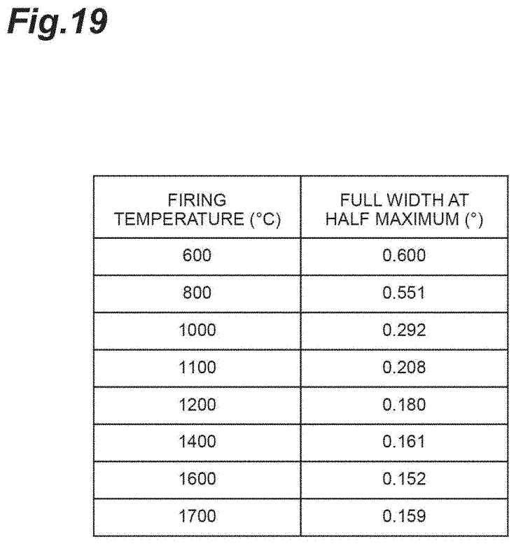

Further, FIG. 18 is a graph showing a relationship between the full width at half maximum of the diffraction intensity peak waveform corresponding to the <200> plane and the firing temperature. Also, FIG. 19 is a chart showing numerical values on which FIG. 18 is based. With reference to FIGS. 18 and 19, it can be seen that the full width at half maximum of the diffraction intensity peak waveform of the <200> plane is gradually narrowed as the firing temperature increases, but it saturates at a firing temperature of around 1400° C. The full width at half maximum at this time is about 0.16°. In addition, with reference to FIG. 18, it can be seen that the full width at half maximum in a case in which the firing temperature is 1050° C. is 0.25°, and the full width at half maximum in a case in which the firing temperature is 1100° C. is approximately 0.2°.

Although the diffraction peak intensity changes depending on irradiation conditions such as an X-ray intensity and an irradiation time, the full width at half maximum of the diffraction intensity peak waveform is a qualitative value determined in accordance with the crystallinity, and thus it does not depend on X-ray irradiation conditions. That is, the firing temperature at the time of preparing the samples can be replaced with the full width at half maximum of the diffraction intensity peak waveform, and by measuring the full width at half maximum of the diffraction intensity peak waveform, the firing temperature at the time of preparing the samples can be ascertained. The full width at half maximum of the diffraction intensity peak waveform of the <200> plane in the phosphor 14 described in the above embodiment corresponds to the firing temperature in the third step S13 at the time of producing the phosphor 14.

### First Comparative Example

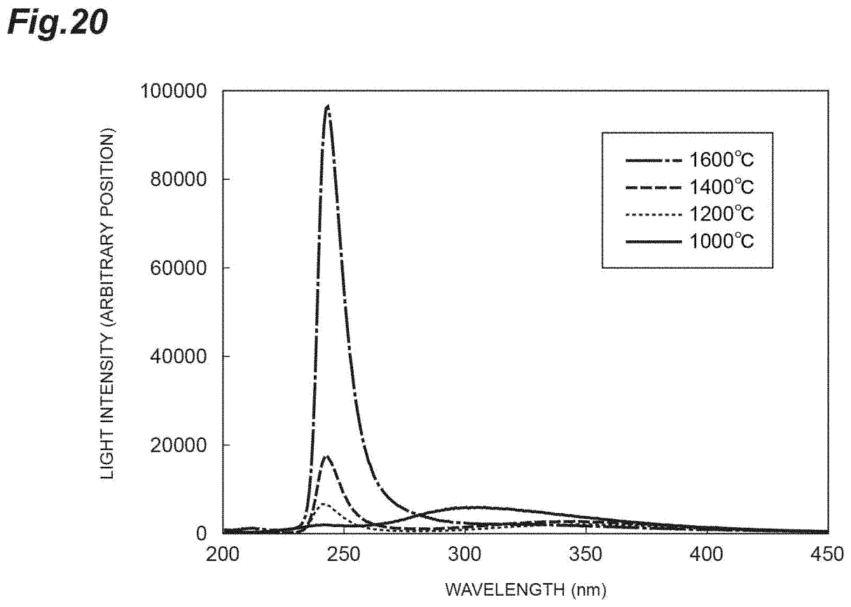

Subsequently, a comparative example of the above embodiment will be described. The author of the present disclosure prepared a plurality of samples to which Bi was added in addition to Sc as an activator and investigated their light emitting characteristics. Also, a producing method and an experiment device are the same as those in the above embodiment except that Bi₂O₃ is added to the material. However, a concentration of Sc in components without P and O was 5 mol %, and a concentration of Bi was 0.5 mol %. Further, the firing temperature of each sample was 1000° C., 1200° C., 1400° C., and 1600° C. FIG. 20 is a graph showing a light emission spectrum for each firing temperature obtained in the present examples. With reference to FIG. 20, it can be seen that the samples emit UV light having a wavelength of around 240 nm even in a case in which Bi is added. In addition, it can be seen that the light emission intensity increases as the firing temperature increases, and the maximum light emission intensity is obtained at 1600° C.

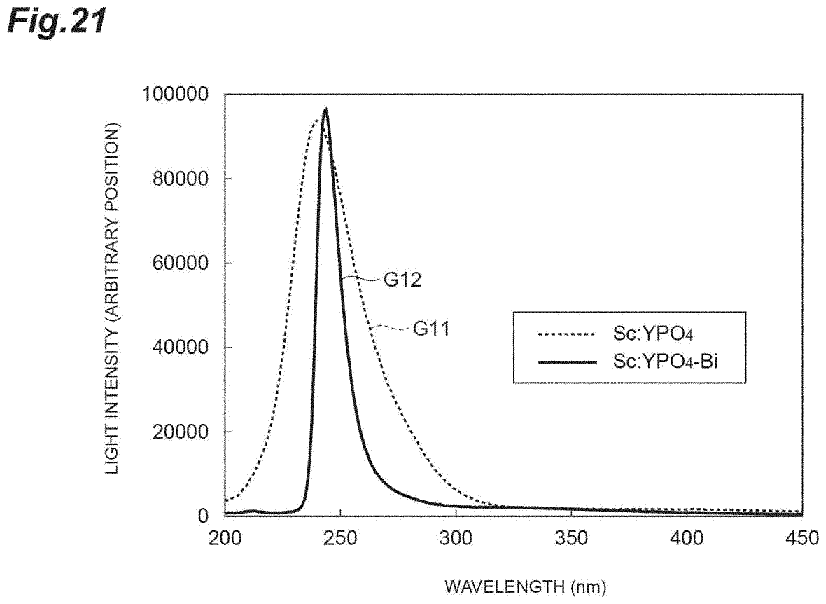

However, there are the following differences between the case in which Bi is added and the case in which Bi is not added. FIG. 21 is a graph in which a light emission spectrum G11 of a Sc:YPO₄ crystal having a firing temperature of 1600° C. and a light emission spectrum G12 in the case of further adding Bi to the Sc:YPO₄ crystal having the same firing temperature are superimposed. Referring to FIG. 21, peak intensities of the same degree are obtained, but a full width at half maximum of a peak waveform of the light emission spectrum G11 is larger than a full width at half maximum of a peak waveform of the light emission spectrum G12. That is, a total amount of light emitted by integrating these light emission spectra G11 and G12 is larger in the Sc:YPO₄ crystal in which Bi is not added than in the case in which Bi is added to the Sc:YPO₄ crystal.

### Second Example

Next, a second example of the above embodiment will be described. The author of the present disclosure actually prepared a plurality of samples (Sc:YPO₄) as the phosphor 14 by using each of the liquid phase method and the solid phase method.

### <Production in Liquid Phase Method>

In order to prepare 2 grains of 5 mol % Sc:YPO₄, 0.038 grams of Sc₂O₃ powder and 1.181 grams of Y₂O₃ powder were weighed. These were mixed in H₃PO₄ (liquid) to prepare a mixture. Then, the mixture was fired by heating it in an electric furnace (1600° C. in the air).

### <Production in Solid Phase Method>

In order to prepare 2 grams of 5 mol % Sc:YPO₄, 0.038 g of Sc₂O₃ powder, 1.181 g of Y₂O₃ powder, and 1.266 g of NH₄H₂PO₄ powder were weighed. These were mixed to prepare a mixture, which was then fired by heating in an electric furnace (1600° C. in the air).

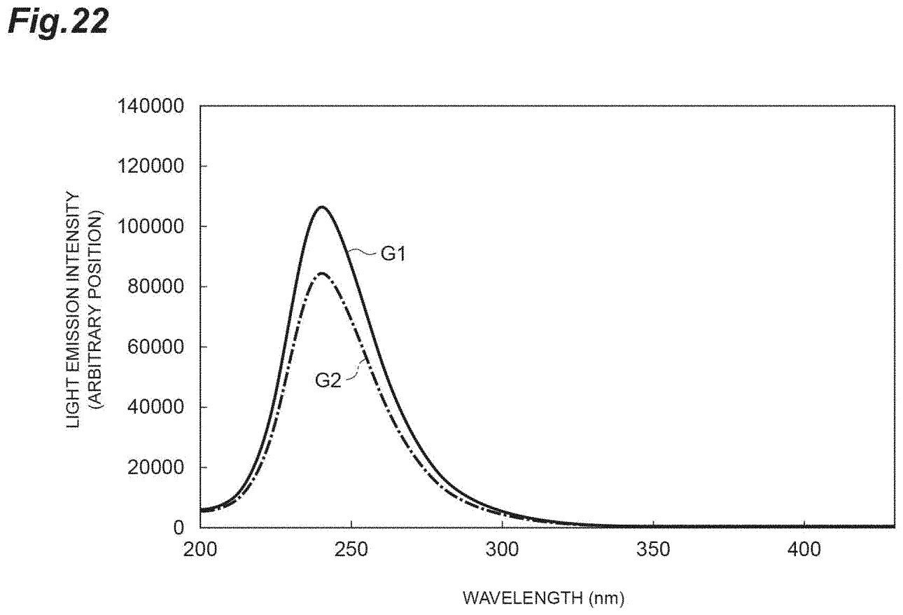

Subsequently, a sample prepared by using each of the liquid phase method and the solid phase method was applied in a film shape on a quartz substrate, and this was excited by an Xe lamp (a wavelength of 172 nm) to measure a light emission spectrum. FIG. 22 is a graph showing the measurement results. In the figure, a graph G1 shows results obtained by the liquid phase method, and a graph G2 shows results obtained by the solid phase method. As shown in the figure, in the liquid phase method, both a peak value of the light emission intensity and a total amount of light emission were larger than those in the solid phase method.

The UV emitting phosphor, the method for producing the UV emitting phosphor, and the UV excitation light source according to the present disclosure are not limited to the examples of the above-described embodiment, and are intended to be represented by the claims and include all changes within the meaning and scope equivalent to the claims.

Although the excimer lamp has been exemplified as the light source for irradiating the UV emitting phosphor with UV light in the above embodiment, the light source is not limited thereto and various other light emitting devices capable of outputting UV light can be used. Further, although the ScₓY₁₋ₓPO₄ crystal containing no Bi has been exemplified in the above embodiment, it does not prevent inclusion of a small amount of Bi within the range of providing the effects of the above embodiment.

### REFERENCE SIGNS LIST

10A, 10B, 10C UV excitation light source
11 Container
12, 13 Electrode
14 UV emitting phosphor
30 Device
32 UV light source
34 Quartz substrate
35 Sample
36 Optical fiber
37 Spectroscopic detector
UV1, UV2 UV light

1. A UV emitting phosphor that contains ScₓY₁₋ₓPO₄ crystals (where, 0<x<1) and receives UV light having a first wavelength to generate UV light having a second wavelength longer than the first wavelength.

2. The UV emitting phosphor according to claim 1, wherein a molar composition ratio x of Sc is 0.02 or more and 0.6 or less.

3. The UV emitting phosphor according to claim 1, wherein a full width at half maximum of a diffraction intensity peak waveform of a <200> plane measured by an X-ray diffractometer using CuKα rays is 0.25° or less.

4. A method for producing the UV emitting phosphor according to claim 1, comprising:
preparing a mixture containing an oxide of yttrium (Y), an oxide of scandium (Sc), phosphoric acid or a phosphoric acid compound, and a liquid;
vaporizing the liquid; and
firing the mixture.

5. The method for producing the UV emitting phosphor according to claim 4, wherein, in the preparing, a mixing proportion of the oxide of Sc without the phosphoric acid and the phosphoric acid compound is 1.2% by mass or more and 47.8% by mass or less.

6. The method for producing the UV emitting phosphor according to claim 4, wherein, in the third step firing, a firing temperature is set to 1050° C. or higher.

7. A UV excitation light source comprising:
the UV emitting phosphor according to claim 1; and
a light source configured to irradiate the UV emitting phosphor with UV light having the first wavelength.
